(19) United States
(12) Patent Application Publication
(10) Pub. No.: US 2017/0024049 A1
(43) Pub. Date: Jan. 26, 2017

(54) INPUT DEVICE

(71) Applicant: FUJIKURA LTD., Kohtoh-ku, Tokyo (JP)

(72) Inventors: Yasuyuki TACHIKAWA, Sakura-shi (JP); Toshimizu TOMITSUKA, Sakura-shi (JP); Makoto TAKAMATSU, Sakura-shi (JP); Osamu AOKI, Sakura-shi (JP); Toshiaki WATANABE, Sakura-shi (JP)

(73) Assignee: FUJIKURA LTD., Kohtoh-ku, Tokyo (JP)

(21) Appl. No.: 15/039,656

(22) PCT Filed: Nov. 27, 2014
(86) PCT No.: PCT/JP2014/081452

§ 371 Date: May 26, 2016

(30) Foreign Application Priority Data
Nov. 29, 2013 (JP) 2013-247332

(51) Int. Cl. G06F 3/041; G06F 3/044

(52) U.S. Cl. CPC G06F 3/0416; G06F 3/044; G06F 3/0412; G06F 2203/04105; G06F 2203/04111

(57) ABSTRACT

An input device 1 includes a panel unit 10, a pressure-sensitive sensor 60 which detects a pressing force applied through the panel unit 10, a seal member 70 which is disposed outside the pressure-sensitive sensors 60, and a support member 80 which supports the panel unit 10 through the pressure-sensitive sensors 60 and the seal member 70. The thickness of the pressure-sensitive sensors 60 is relatively thinner than the thickness of the seal member 70, a space which is formed between the panel unit 10 and the support member 80 includes a first part S₁ where the pressure-sensitive sensors 60 are arranged and the second part S₂ where the seal member 70 is arranged, and the distance of the first part S₁ is relatively narrower than the distance of the second part S₂.

### TECHNICAL FIELD

The present invention relates to an input device including a panel unit and a pressure-sensitive sensor which detects pressing force applied through the panel unit.

For designated countries which permit the incorporation by reference, the contents described and/or illustrated in the documents relevant to Japanese Patent Application No. 2013-247332 filed on Nov. 29, 2013 will be incorporated herein by reference as a part of the description and/or drawings of the present application.

### BACKGROUND ART

There is known an input device having four pressure-sensitive sensors disposed between a touch panel and a case and in which a sponge is arranged in a frame shape between a top plate and the case to prevent dust or the like from entering from the outside (for example, refer to paragraph [0060] in Patent Document 1).

### PRIOR ART DOCUMENT

### Patent Document

[Patent Document 1] JP 2010-244514 A

### SUMMARY OF INVENTION

### Problems to be Solved by Invention

In the above-described input device, when pressing the pressure-sensitive sensors through the touch panel, the pressing force is released to the sponge and the pressing force transmitted to the pressure-sensitive sensors is weaker than a real pressing force. Accordingly, there is a problem that the pressure-sensitive sensors cannot detect the pressing force accurately.

An object of the present invention is to provide an input device capable of improving detection accuracy of the pressure-sensitive sensors.

### Means for Solving Problems

[1] An input device according to the present invention includes a panel unit, a pressure-sensitive sensor which detects a pressing force applied through the panel unit, a seal member which is disposed outside the pressure-sensitive sensor, and a support which supports the panel unit through the pressure-sensitive sensor and the seal member. The thickness of the pressure-sensitive sensor is relatively thinner than the thickness of the seal member, and the space which is formed between the panel unit and the support includes the first part where the pressure-sensitive sensor is arranged and the second part where the seal member is arranged. The distance of the first part is relatively narrower than the distance of the second part.

[2] In the invention, the pressure-sensitive sensor may include a detecting part which detects the pressing force and an elastic member which is disposed on at least one of an upper side and a lower side of the detecting part.

[3] In the invention, an elasticity modulus of the elastic member may be relatively higher than an elasticity modulus of the seal member.

[4] In the invention, the input device may further include a restriction device which restricts the panel unit from separating from the support by a prescribed distance or more.

[5] An input device according to the present invention includes a panel unit, a pressure-sensitive sensor which detects a pressing force applied through the panel unit, a seal member which is disposed outside the pressure-sensitive sensor, and a support which supports the panel unit through the pressure-sensitive sensor and the seal member. The pressure-sensitive sensor includes a detecting part which detects the pressing force and an elastic member which is disposed on at least one of an upper side and a lower side of the detecting part. An elasticity modulus of the elastic member is relatively higher than an elasticity modulus of the seal member.

[6] In the invention, the panel unit may at least include a position input function.

### Effect of Invention

In the invention, the thickness of pressure-sensitive sensor is relatively thinner than the thickness of a seal member. In this way, pressing force can be accurately transmitted to the pressure-sensitive sensor and detection accuracy of the pressure-sensitive sensor can be improved.

Further, in the invention, the elasticity modulus of the elastic member is relatively higher than the elasticity modulus of the seal member. In this way, pressing force can be accurately transmitted to the pressure-sensitive sensor and detection accuracy of the pressure-sensitive sensor can be improved.

### BRIEF DESCRIPTION OF DRAWINGS

FIG. 1 is a plan view of an input device in the first embodiment of the present invention.

FIG. 2 is a cross-sectional view taken along line II-II in FIG. 1.

FIG. 3 is an exploded perspective view of a touch panel in the first embodiment of the present invention.

FIG. 4 is a cross-sectional view of a pressure-sensitive sensor in the first embodiment of the present invention.

FIG. 5 is an enlarged cross-sectional view showing a modification example of the pressure-sensitive sensor in the first embodiment of the present invention.

FIG. 6 is an enlarged view of the part VI in FIG. 2.

FIG. 7 is a graph showing stress-displacement curves of two elastic bodies having different thickness and having the same elasticity modulus.

FIG. 8 is an enlarged cross-sectional view showing the first modification example of an input device in the first embodiment of the present invention.

FIG. 9 is an enlarged cross-sectional view showing the second modification example of the input device in the first embodiment of the present invention.

FIG. 10 is a graph showing a stress-strain curve of the two elastic bodies having different elasticity moduli and having the same thickness.

FIG. 11 is a plan view of a display device in the first embodiment of the present invention.

FIG. 12 is a cross-sectional view of an input device in the second embodiment of the present invention.

FIG. 13 is a plan view showing an input device of the third embodiment of the present invention.

FIG. 14 is a cross-sectional view taken along line XIV-XIV in FIG. 13.

FIG. 15 is a bottom view of a reinforcing member in the third embodiment of the present invention.

FIG. 16 is a cross-sectional view showing a modification example of the input device in the third embodiment of the present invention.

FIG. 17 is a cross-sectional view showing an input device in the fourth embodiment of the present invention.

FIG. 18 is a cross-sectional view of an input device in the fifth embodiment of the present invention.

### MODES FOR CARRYING OUT THE INVENTION

Hereinafter, embodiments of the present invention will be described with reference to the accompanying drawings.

### First Embodiment

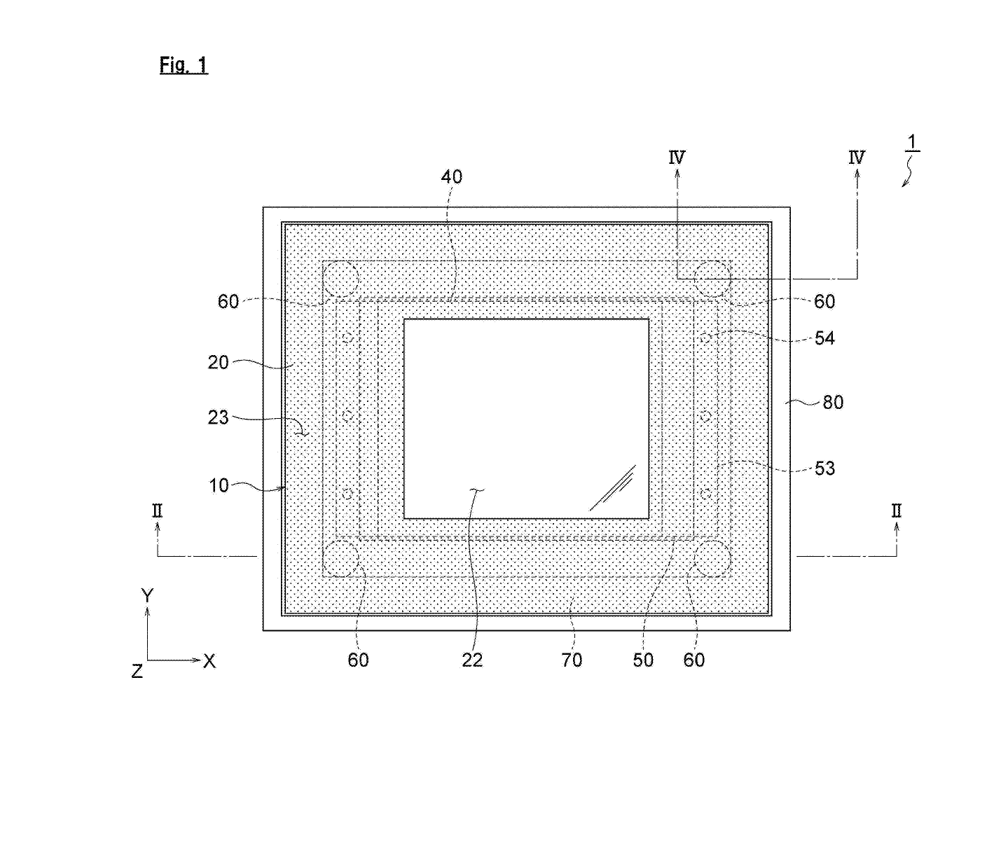

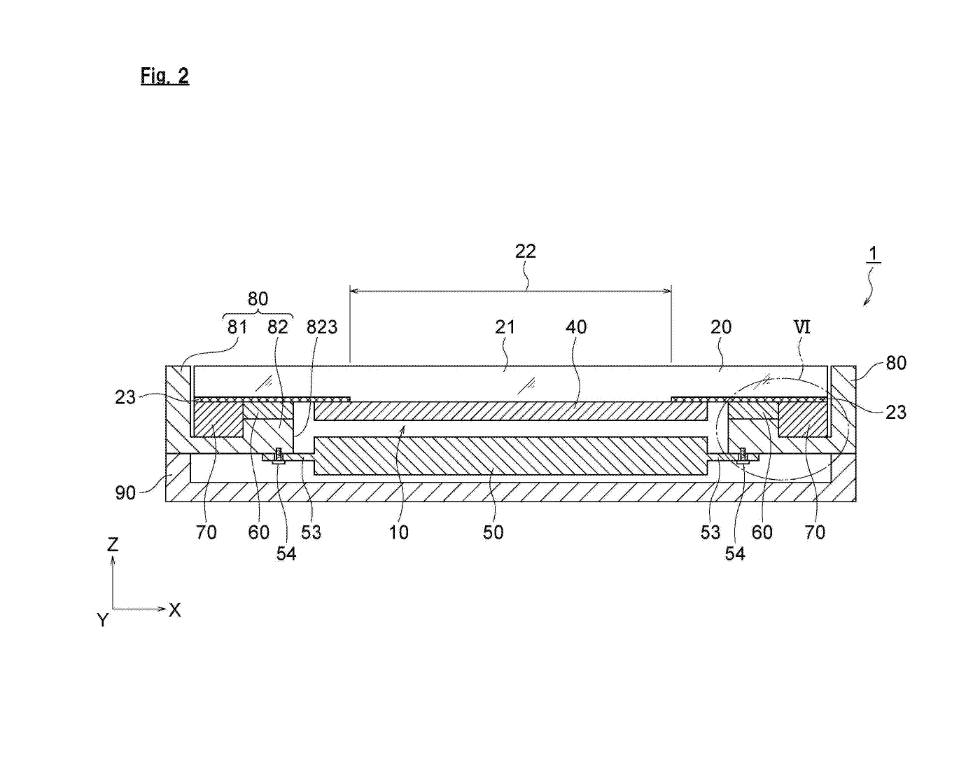

FIG. 1 is a plan view and FIG. 2 is a cross-sectional view of an input device in the first embodiment of the present invention.

As illustrated in FIG. 1 and FIG. 2, an input device (electronic apparatus) 1 in the first embodiment of the present invention includes a panel unit 10, a display device 50, pressure-sensitive sensors 60, a seal member 70, the first support member 80, and the second support member 90. The panel unit 10 includes a cover member 20 and a touch panel 40. The panel unit 10 is supported by the first support member 80 through the pressure-sensitive sensors 60 and the seal member 70, and a minute vertical movement of the panel unit 10 with respect to the first support member 80 is permitted due to the elastic deformations of the pressure-sensitive sensors 60 and the seal member 70.

The input device 1 can display an image by the display device 50 (display function). In addition, in a case where an arbitrary position on a display is indicated by a finger of an operator, a touch pen, and the like, the input device 1 is capable of detecting XY coordinates of the position with the touch panel 40 (position input function). Further, in a case where the panel unit 10 is pressed in the Z-direction with a finger of the operator and the like, the input device 1 can detect the pressing operation with the pressure-sensitive sensors 60 (a pressure detection function).

As illustrated in FIG. 1 and FIG. 2, the cover member 20 is constituted by a transparent substrate 21 through which visible light beams can be transmitted. Specific examples of such material of which the transparent substrate 21 is made include glass, polymetylmethacrylate (PMMA), polycarbonate (PC), and the like.

For example, a shielding portion (bezel portion) 23, which is formed by applying white ink, black ink, and the like, is provided on a lower surface of the transparent substrate 21. The shielding portion 23 is formed in a frame-like shape in a region on the lower surface of the transparent substrate 21 except for a rectangular transparent portion 22 which is located at the center of the lower surface.

The shapes of the transparent portion 22 and the shielding portion 23 are not particularly limited to the above-described shapes. A decorating member which is decorated with a white color or a black color may be laminated on a lower surface of the transparent substrate 21 so as to form the shielding portion 23. Alternatively, a transparent sheet, which has substantially the same size as the transparent substrate 21 and in which only a portion corresponding to the shielding portion 23 is colored with a white color or a black color, may be prepared, and the sheet may be laminated on the lower surface of the transparent substrate 21 so as to form the shielding portion 23.

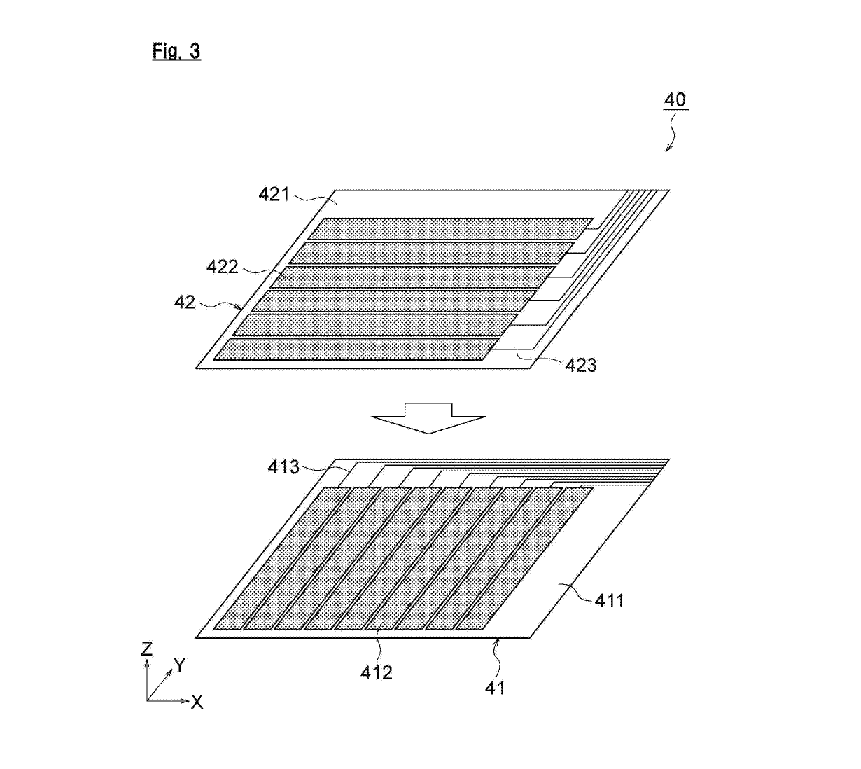

FIG. 3 is an exploded perspective view of a touch panel in the first embodiment of the present invention.

As illustrated in FIG. 3, the touch panel 40 is an electrostatic capacitance type touch panel including two electrode sheets 41 and 42 which overlap each other.

The structure of the touch panel is not particularly limited thereto, and for example, a resistive film type touch panel or an electromagnetic induction type touch panel may be employed. The following electrode patterns 412 and 422 may be formed on the lower surface of the cover member 20, and the cover member 20 may be used as a part of the touch panel. Alternatively, a touch panel prepared by forming an electrode on both surfaces of a sheet may be used instead of the two electrode sheets 41 and 42.

The first electrode sheet 41 includes a first transparent base material (substrate) 411 through which visible light beams can be transmitted, and first electrode patterns 412 which are provided on the first transparent base material 411.

Specific examples of a material of which the first transparent base material 411 is made include resin materials such as polyethylene terephthalate (PET), polyethylene naphthalate (PEN), polyethylene (PE), polypropylene (PP), polystyrene (PS), an ethylene-vinyl acetate copolymer resin (EVA), vinyl resin, polycarbonate (PC), polyamide (PA), polyimide (PI), polyvinyl alcohol (PVA), an acrylic resin, and triacetyl cellulose (TAC) and glass.

For example, the first electrode patterns 412 are transparent electrodes which are made of indium tin oxide (ITO) or a conductive polymer, and are configured as strip-like face patterns (so-called solid patterns) which extend in the Y-direction in FIG. 3. In an example illustrated in FIG. 3, nine first electrode patterns 412 are arranged in parallel on the first transparent base material 411. The shape, the number, the arrangement, and the like of the first electrode patterns 412 are not particularly limited to the above-described configurations.

In the case where the first electrode patterns 412 are made of ITO, for example, the first electrode patterns 412 are formed through sputtering, photolithography, and etching. On the other hand, in the case where the first electrode patterns 412 are made of a conductive polymer, the first electrode patterns 412 can be formed through sputtering and the like similar to the case of ITO, or can be formed through a printing method such as screen printing and gravure-offset printing, or through etching after coating.

Specific examples of the conductive polymer of which the first electrode patterns 412 are made include organic compounds such as a polythiophene-based compound, a polypyrrole-based compound, a polyaniline-based compound, a polyacetylene-based compound, and a polyphenylene-based compound. A PEDOT/PSS compound is preferably used among these compounds.

The first electrode patterns 412 may be formed by printing conductive paste on the first transparent base material 411 and by curing the conductive paste. In this case, each of the first electrode patterns 412 is formed in a mesh shape instead of the face pattern so as to secure sufficient light transmittance of the touch panel 40. As the conductive paste, for example, conductive paste obtained by mixing metal particles such as silver (Ag) and copper (Cu) and a binder such as polyester and polyphenol can be used.

The first electrode patterns 412 are connected to a touch panel drive circuit not particularly shown in figures through a first lead-out wiring pattern 413. The first lead-out wiring pattern 413 is provided at a position, which faces the shielding portion 23 of the cover member 20, on the first transparent base material 411, and the first lead-out wiring pattern 413 is not visually recognized to the operator. Therefore, the first lead-out wiring pattern 413 is formed by printing conductive paste on the first transparent base material 411 and by curing the conductive paste.

The second electrode sheet 42 also includes a second transparent base material (substrate) 421 through which visible light beams can be transmitted, and second electrode patterns 422 which are provided on the second transparent base material 421.

The second transparent base material 421 is made of the same material as in the above-described first transparent base material 411. Similar to the above-described first electrode patterns 412, the second electrode patterns 422 are also transparent electrodes which are made of, for example, indium tin oxide (ITO) or a conductive polymer.

The second electrode patterns 422 are configured as strip-like face patterns which extend in the X-direction in FIG. 3. In an example illustrated in FIG. 3, six second electrode patterns 422 are arranged in parallel on the second transparent base material 421. The shape, the number, the arrangement, and the like of the second electrode patterns 422 are not particularly limited to the above-described configurations.

The second electrode patterns 422 are connected to the touch panel drive circuit not particularly shown in figures through a second lead-out wiring pattern 423. For example, the touch panel drive circuit periodically applies a predetermined voltage between the first electrode patterns 412 and the second electrode patterns 422, and detects a position of a finger on the touch panel 40 on the basis of a variation in electrostatic capacitance at each intersection between the first and second electrode patterns 412 and 422.

The second lead-out wiring pattern 423 is provided at a position, which faces the shielding portion 23 of the cover member 20, on the second transparent base material 421, and the second lead-out wiring pattern 423 is not visually recognized to the operator. Therefore, similar to the above-described first lead-out wiring pattern 413, the second lead-out wiring pattern 423 is also formed by printing conductive paste on the second transparent base material 421 and by curing the conductive paste.

The first electrode sheet 41 and the second electrode sheet 42 are attached to each other through a transparent gluing agent in such a manner that the first electrode patterns 412 and the second electrode patterns 422 are substantially orthogonal to each other in a plan view. The touch panel 40 itself is attached to the lower surface of the cover member 20 through the transparent gluing agent in such a manner that the first and second electrode patterns 412 and 422 face the transparent portion 22 of the cover member 20. Specific examples of the transparent gluing agent include an acryl-based gluing agent, and the like.

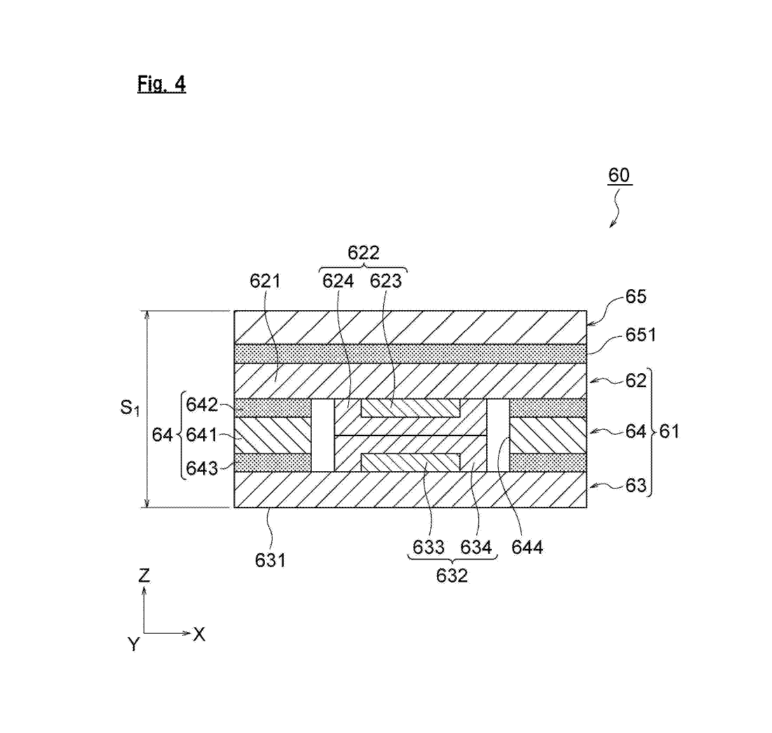

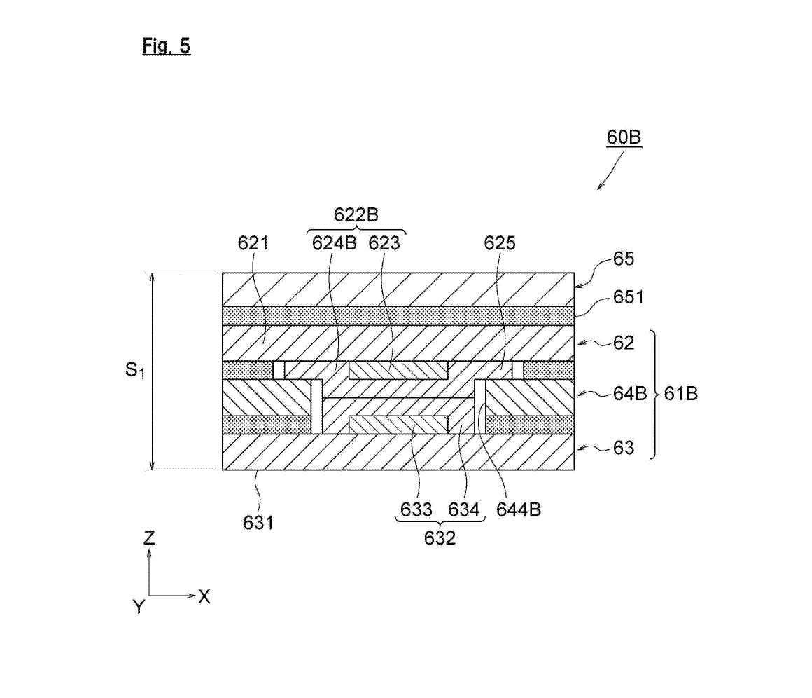

FIG. 4 is a cross-sectional view of a pressure-sensitive sensor in the first embodiment of the present invention, and FIG. 5 is an enlarged cross-sectional view showing a modification example of the pressure-sensitive sensor in the first embodiment of the present invention.

The panel unit 10 constituted by the above-described cover member 20 and touch panel 40 is supported by the first support member 80 through pressure-sensitive sensors 60 and a serial member 70 as shown in FIG. 2. As shown in FIG. 1, the pressure-sensitive sensors 60 are arranged at the four corners of the panel unit 10. On the other hand, the seal member 70 having a rectangular annular shape is disposed outside the pressure-sensitive sensors 60 and arranged over the entire circumference of the panel unit 10C along the outer edge of the panel unit 10. The pressure-sensitive sensors 60 and the seal member 70 are each attached to the lower surface of the cover member 20 through a gluing agent and also to the first support member 80 through the gluing agent. The number and the arrangement of the pressure-sensitive sensors 60 are not particularly limited as long as the pressure-sensitive sensors 60 can stably hold the panel unit 10.

As illustrated in FIG. 4, each of the pressure-sensitive sensors 60 includes a detecting part 61 and an elastic member 65. The detecting part 61 includes a first electrode sheet 62, a second electrode sheet 63, and a spacer 64 which is interposed therebetween. FIG. 4 is a cross-sectional view taken along line IV-IV in FIG. 1.

The first electrode sheet 62 includes a first base material (substrate) 621 and an upper electrode 622. The first base material 621 is a flexible insulating film, and is made of, for example, polyethylene terephthalate (PET), polyethylene naphthalate (PEN), polyimide (PI), polyetherimide (PEI), and the like.

The upper electrode 622 includes a first upper electrode layer 623 and a second upper electrode layer 624, and is provided on a lower surface of the first base material 621. The first upper electrode layer 623 is formed by printing conductive paste, which has a relatively low electric resistance, on the lower surface of the first base material 621, and by curing the conductive paste. On the other hand, the second upper electrode layer 624 is formed by printing the conductive paste, which has a relatively high electric resistance, on the lower surface of the first base material 621 so as to cover the first upper electrode layer 623, and by curing the conductive paste.

The second electrode sheet 63 also includes a second base material (substrate) 631 and a lower electrode 632. The second base material 631 is made of the same material as in the above-described first base material 621. The lower electrode 632 includes a first lower electrode layer 633 and a second lower electrode layer 634, and is provided on an upper surface of the second base material 631.

Similar to the above-described first upper electrode layer 623, the first lower electrode layer 633 is formed by printing a conductive paste, which has a relatively low electric resistance, on an upper surface of the second base material 631, and by curing the conductive paste. On the other hand, similar to the above-described second upper electrode layer 624, the second lower electrode layer 634 is formed by printing the conductive paste, which has a relatively high electric resistance, on the upper surface of the second base material 631 so as to cover the first lower electrode layer 633, and by curing the conductive paste.

Examples of a conductive paste, which has a relatively low electric resistance, include silver (Ag) paste, gold (Au) paste, and copper (Cu) paste. In contrast, examples of a conductive past, which has a relatively high electric resistance, include carbon (C) paste. More, examples of a method of printing the conductive paste include screen printing, gravure-offset printing, an inkjet method, and the like.

The first electrode sheet 62 and the second electrode sheet 63 are laminated through the spacer 64. The spacer 64 includes a base material (substrate) 641 and gluing layers 642 and 643 laminated to both sides of the base material 641. The base material 641 is made of an insulating material such as polyethylene terephthalate (PET), polyethylene naphthalate (PEN), polyimide (PI), and polyetherimide (PEI). The base material 641 is attached to the first electrode sheet 62 through the gluing layer 642 and the second electrode sheet 63 through the gluing layer 643.

A through-hole 644 is formed in the spacer 64 at a position which corresponds to the upper electrode 622 and the lower electrode 632. The upper electrode 622 and the lower electrode 632 are located inside the through-hole 644 and are faced each other. The thickness of the spacer 64 is adjusted so that the upper electrode 622 and the lower electrode 632 come into contact with each other in a state where no pressure is applied to the pressure-sensitive sensors 60. In a non-load state, the upper electrode 622 and the lower electrode 632 may not come into contact with each other. However, when the upper electrode 622 and the lower electrode 632 are brought into contact with each other in advance in a non-load state, a problem, in which the electrodes do not contact with each other even when a pressure is applied (that is, an output of the pressure-sensitive sensor 60 is zero (0)), does not occur, and detection accuracy of the pressure-sensitive sensors can be improved.

In a state in which a predetermined voltage is applied between the upper electrode 622 and the lower electrode 632 and when a load from an upper side to the pressure-sensitive sensor 60 increases, a degree of adhesion between the upper electrode 622 and the lower electrode 632 increases in accordance with the size of the load, and electric resistance between the electrodes 622 and 632 decreases. On the other hand, when the load to the pressure-sensitive sensor 60 is released, the degree of adhesion between the upper electrode 622 and the lower electrode 632 lowers and electric resistance between the electrodes 622 and 632 increases. Accordingly, the pressure-sensitive sensor 60 is capable of detecting the size of the pressure applied to the pressure-sensitive sensor 60 on the basis of the resistivity change. The input device 1 in the present embodiment detects the pressing operation by an operator to the panel unit 10 by comparing an electric resistance value of the pressure-sensitive sensor 60 with a predetermined threshold value. In the present embodiment, “an increase in the degree of adhesion” means an increase in a microscopic contact area, and “a decrease in the degree of adhesion” means a decrease in the microscopic contact area.

The second upper electrode layer 624 or the second lower electrode layer 634 can be formed by printing a pressure-sensitive ink instead of the carbon paste, and by curing the pressure-sensitive ink. The electrode layers 623, 624, 633, and 634 can be formed through a plating process or a patterning process instead of the printing method. In a plan view, when the distance from the center of the panel unit to each of the pressure-sensitive sensors varies, sensitivity of the sensitive sensor closer to the center of the panel unit may be lowered. Specifically, resistance value of the pressure-sensitive sensor may be raised or the pressure-sensitive sensor may be made not to bend easily so as to lower sensitivity of the pressure-sensitive sensor.

An elastic member 65 is laminated on the first electrode sheet 62 through the gluing agent 651. The elastic member 65 is constituted by an elastic material such as a foaming material or rubber material. Specific examples of the foaming material constituting the elastic member 65 include, for example, a urethane foam, a polyethylene foam, and a silicone foam each of which has closed cells. Further, examples of the rubber material constituting the elastic member 65 include a polyurethane rubber, a polystyrene rubber, and a silicone rubber.

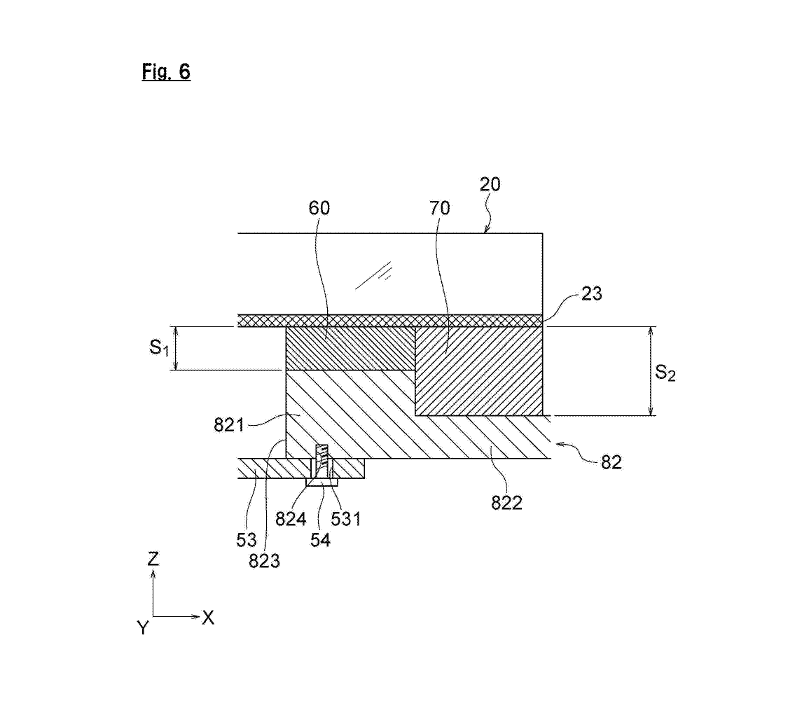

In the present embodiment, the elastic member 65 is thinner than usual. Accordingly, the total thickness of the pressure-sensitive sensor 60 is relatively thinner than the thickness of the seal member 70 (refer to FIG. 2 and FIG. 6). The elastic member 65 may be laminated under the second electrode sheet 63. Alternatively, the elastic members 65 may be laminated on the first electrode sheet 62 and also under the second electrode sheet 63.

By providing the elastic member 65 to the pressure-sensitive sensor 60, the load applied to the pressure-sensitive sensor 60 can be dispersed evenly throughout the detecting part 61 and detection accuracy of the pressure-sensitive sensor 60 can be improved. When the support member 80, 90 or the like is distorted or when the tolerance in the thickness direction of the support member 80, 90 or the like is large, the distortion and tolerance can be absorbed by the elastic member 65. Damage or destruction of the pressure-sensitive sensor 60 can also be prevented when excess pressure or shock is applied to the pressure-sensitive sensor 60.

The structure of the pressure-sensitive sensor is not particularly limited to the above. For example, as in the pressure-sensitive sensor 60B shown in FIG. 5, by forming an annular protruding part 625 by the second upper electrode layer 624B of the upper electrode 622B, the spacer 64B may be sandwiched between the protruding part 625 and the second base material 631. The protruding part 625 protrudes radially from the upper part of the upper electrode 622B. Further, as for the spacer 64B in the present example, diameter of an upper part opening of the through-hole 644B is expanded and the protruding part 625 of the upper electrode 622B can be housed therein.

Instead of the pressure-sensitive sensors having the structure explained above, a piezoelectric element or strain gauge can be used as the pressure-sensitive sensor. Alternatively, a Micro Electro Mechanical Systems (MEMS) element of a cantilevered shape (or a both-ends supported shape) having a piezo-resistance layer may be used as the pressure-sensitive sensor. Alternatively, a pressure-sensitive sensor having a structure of sandwiching polyamino acid material having piezoelectricity between insulating substrates each having formed with an electrode by screen printing may be used as the pressure-sensitive sensor. Alternatively, a piezoelectric element utilizing polyvinylidene fluoride (PVDF) having piezoelectricity may be used as a pressure-sensitive sensor.

As with the elastic member 65, a seal member 70 is also made of an elastic material such as a foaming material, rubber material or the like. Specific examples of the foaming material constituting the seal member are, for example, urethane foam, a polyethylene foam, a silicone foam, etc. each of which has closed cells. Further, examples of the rubber material constituting the seal member 70 include a polyurethane rubber, a polystyrene rubber, a silicone rubber and the like.

In the present embodiment, the seal member 70 has an elasticity modulus (a Young's modulus (compressive elasticity modulus)) E₂ which is substantially equal to an elasticity modulus (a Young's modulus (compressive elasticity modulus)) E₁ of the elastic member 65 in the pressure sensitive sensor 60 (E₁=E₂). In the present example, the elasticity modulus E₁ of the elastic member 65 may be relatively higher than the elasticity modulus E₂ of the seal member 70 (E₁>E₂). By placing the seal member 70 between a cover member 20 and the first support member 80, invasion of foreign matters from the outside can be prevented.

Specific example of the elasticity modulus (E₁, E₂) of the elastic member 65 and the seal member 70 is about 10 kPa to 5 MPa when the elastic member 65 and seal member 70 are made of foaming materials. Also, when the elastic member 65 and seal member 70 are made of rubber materials, their elasticity modulus (E₁, E₂) can be exemplified by about 5 MPa to 50 MPa.

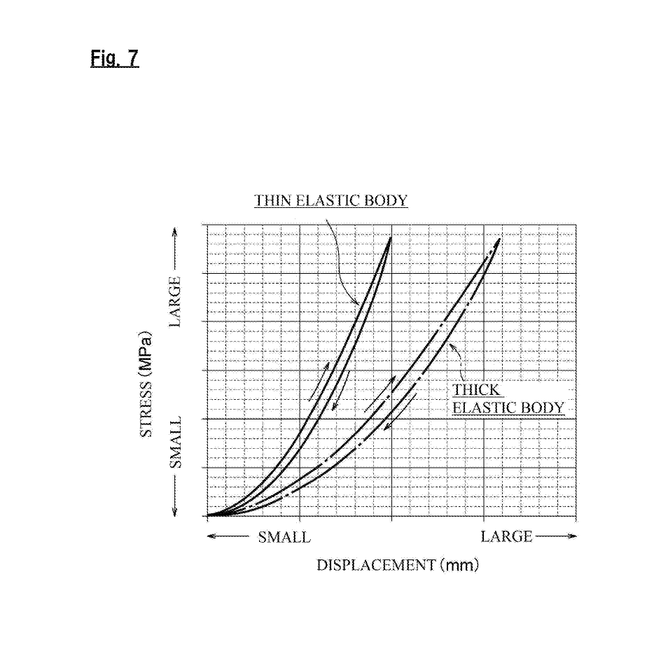

FIG. 6 is an enlarged cross-sectional view showing the relationship between the pressure-sensitive sensor 60 and seal member 70 in the first embodiment of the present invention. FIG. 7 is a graph showing a stress-displacement curve of two elastic bodies having the same elasticity modulus and with different thickness.

As shown in FIG. 2, the pressure-sensitive sensors 60 and the seal member 70 described above are sandwiched between the cover member 20 and the first support member 80. The first support member 80 includes a frame part 81 and a holder 82. The frame part 81 has a rectangular frame shape with an opening capable of housing the cover member 20. On the other hand, the holder 82 has a rectangular annular shape and is radially protruded to the inside from the lower end of the frame part 81. The first support member 80 is made of, for example, a metal material such as aluminum and the like, or a resin material or the like such as polycarbonate (PC), acrylonitrile-butadiene-styrene resin (ABS) resin, and the like. The frame part 81 and the holder 82 are integrally formed.

As shown in FIG. 6, the holder 82 in the present embodiment includes a first region 821 for holding the pressure-sensitive sensors 60 and a second region 822 for holding the seal member 70. The first region 821 is disposed annularly surrounding a center opening 823 of the holder 82. The second region 822 is disposed annularly to the outside of the first region 821 in the radial direction.

The first support member 80 may be constituted by multiple members. For example, the first region 821 and the second region 822 may be constituted by different members and form the first support member 80 by connecting them.

The first region 821 may be formed convexly only at the parts of the holder 82 where the pressure-sensitive sensors 60 are to be placed. Although the pressure-sensitive sensors 60 and the seal member 70 are disposed next to each other in the present embodiment, the pressure-sensitive sensors 60 and the seal member 70 may be disposed apart from each other (in other words, the first region 821 and the second region 822 may be disposed apart from each other).

In the present embodiment, the first region 821 is relatively thicker than the second region 822. Thus, in the space formed between the panel unit 10 and the first support member 80, a distance of the first part S₁ where the pressure-sensitive sensors 60 are placed is relatively narrower than a distance of the second part S₂ where the seal member 70 is placed (S₁<S₂).

In general, in the case where two elastic bodies having the same elasticity modulus differ in their thickness, as shown in FIG. 7, when the displacement amount is the same, the stress value of the thin elastic body is larger than the stress value of the thick elastic body. In the present embodiment, as described above, the distance of the first part S₁ is relatively narrower than the distance of the second part S₂. Thus, when the panel unit 10 is pressed, stress per unit displacement generated to the pressure-sensitive sensors 60 can be relatively larger than the stress per unit displacement generated to the seal member 70.

As an example, preferably the distance of the first part S₁ (that is, the height of the pressure-sensitive sensor 60) is approximately 0.3 mm to 1.5 mm, the distance of the second part S₂ (that is, the height of the seal member 70) is approximately 0.5 mm to 3.0 mm, and the difference ΔS(=S₂−S₁) between the distance of the second part S₂ and the distance of the first part S₁ is approximately 0.1 mm to 2.0 mm.

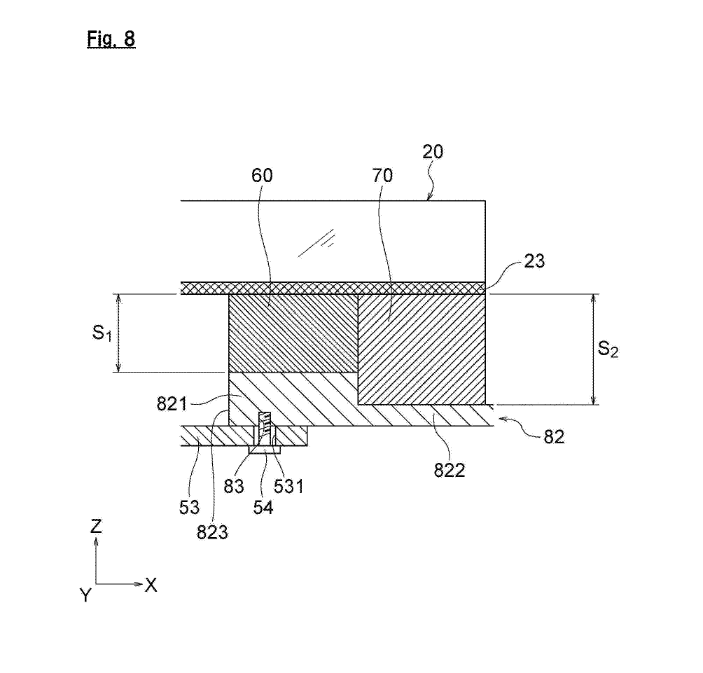

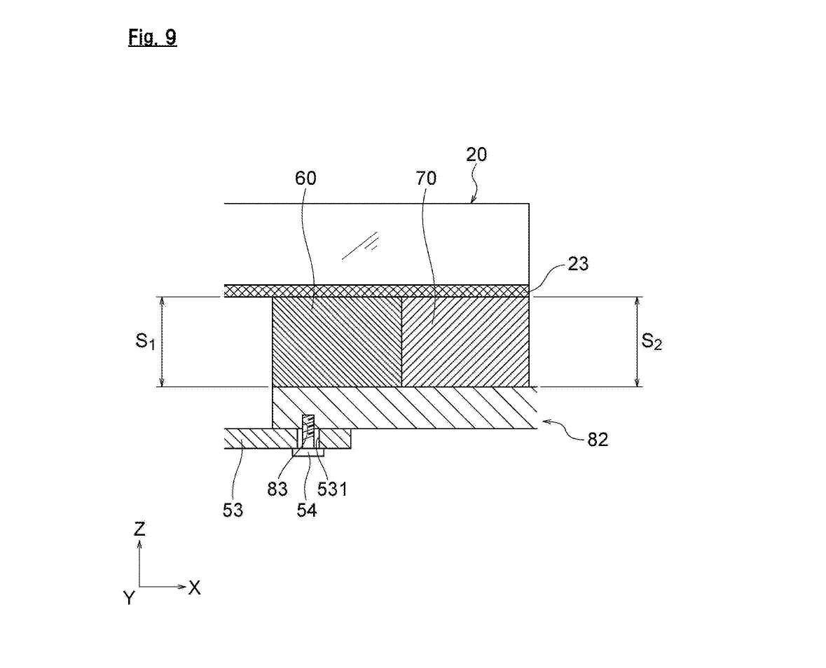

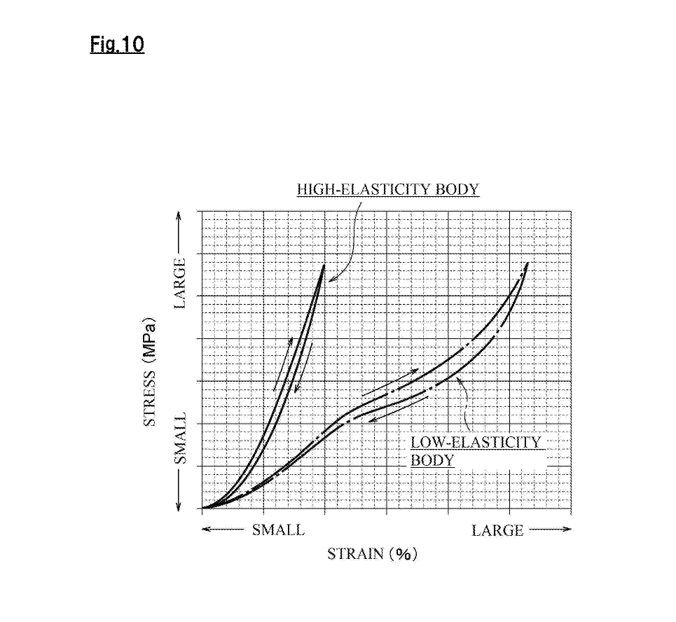

FIG. 8 is an enlarged cross-sectional view showing a first modification example of the input device in the first embodiment of the present invention. FIG. 9 is an enlarged cross-sectional view showing a second modification example of the input device in the first embodiment of the present invention. FIG. 10 is a graph showing a stress-strain curve of two elastic bodies having the same elasticity modulus and having different thickness.

As shown in FIG. 8, the elastic member 65 of the pressure-sensitive sensors 60 may be not thin, but the seal member 70 may be thick and the second region 822 of the holder 82 may be relatively thinner than the first region 821, thereby the distance of the second part S₂ may be relatively wider than the distance of the first part S₁ (S₂>S₁).

Alternatively, as shown in FIG. 9, while the thickness of the first region 821 and the second region 822 of the holder 82 may be substantially the same (in other words, the distance of the first part S₁ and the distance of the second part S₂ may be substantially the same (S₁=S₂)), an elasticity modulus E₁ of the elastic member 65 may be relatively higher than an elasticity modulus E₂ of the seal member 70 (E₁>E₂).

In general, in the case where two elastic bodies having the same thickness differ in their elasticity modulus, as shown in FIG. 10, a high-elasticity body (an elastic body having a high elasticity modulus) is hard to be distorted in comparison with a low-elasticity body (an elastic body having a low elasticity modulus). In the present embodiment, as mentioned above, the elasticity modulus E₁ of the elastic member 65 is relatively higher than the elasticity modulus E₂ of the seal member 70 (E₁>E₂). Thus, the pressure-sensitive sensors 60 are harder to be distorted in comparison with the seal member 70. For this reason, when the panel unit 10 is pressed, the stress per unit displacement generated to the pressure-sensitive sensors 60 can be relatively larger than the stress per unit displacement generated to the seal member 70.

As an example, an elasticity modulus E₁ of the elastic member 65 is preferably two times or more relative to the elasticity modulus E₂ of the seal member 70, and more preferably 10 times or more. For example, an expansion ratio of the material constituting the seal member 70 may be higher than an expansion ration of the material constituting the elastic member 65, thereby the elasticity modulus E₁ of the elastic member 65 can be relatively higher than the elasticity modulus E₂ of the seal member 70. By utilizing the one different from the material constituting the seal member 70 as the material for constituting the elastic member 65, the elasticity modulus E₁ of the elastic member 65 may be relatively higher than the elasticity modulus E₂ of the seal member 70.

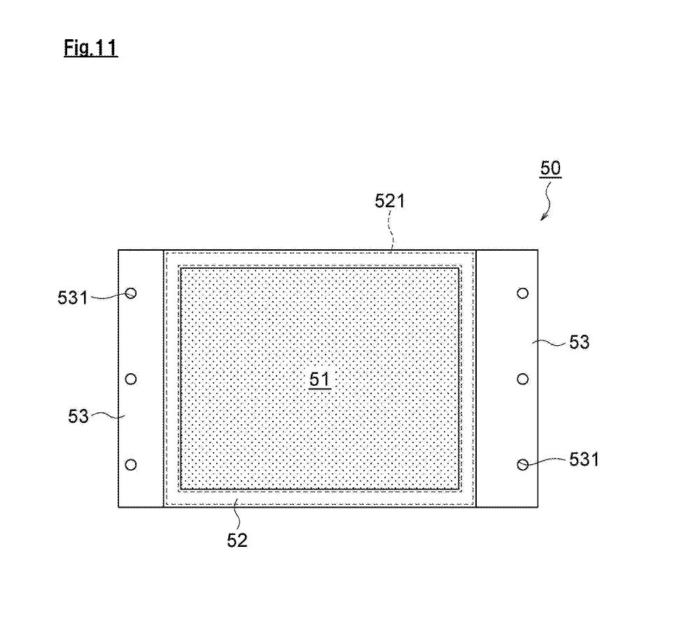

FIG. 11 is a plan view of the display device in the first embodiment of the present invention.

As illustrated in FIG. 11, the display device 50 includes a display region 51 on which an image is displayed, an outer edge region 52 which surrounds the display region 51, and a flange 53 which protrudes from both ends of the outer edge region 52. For example, the display region 51 of the display device 50 is constituted by a thin-type display device such as a liquid crystal display, an organic EL display, or an electronic paper.

A first through-hole 531 is formed in the flange 53. The first through-hole 531 faces a screw hole 824 (see FIG. 6) formed on the rear surface of the first support member 80. As shown in FIG. 2, when a screw 54 is screwed into the screw hole 824 through the first through-hole 531, the display device 50 is fixed to the support member 80. Accordingly, the display region 51 faces a transparent portion 22 of the cover member 20 through a center opening 823 of the first support member 80.

Like the first support member 80 described above, the second support member 90 is made of, for example, a metal material such as aluminum or the like, or a resin material such as polycarbonate (PC), and ABS resin, etc. The second support member 90 is attached to the first support member 80 through a gluing agent so as to cover the rear surface of the display device 50. Instead of the gluing agent, the second support member 90 may be fastened with a screw to the first support member 80.

As above, in the present embodiment, the pressure-sensitive sensors 60 are relatively thinner than the seal member 70. Accordingly, the stress per unit displacement of the pressure-sensitive sensors 60 can be relatively larger than the stress per unit displacement of the seal member 70. For this reason, a pressing force applied through the panel unit 10 can be accurately transmitted to the pressure-sensitive sensors 60, and detection accuracy of the pressure-sensitive sensors 60 improves.

The panel unit 10 in the present embodiment is equivalent to an example of the panel unit in the present invention, the pressure-sensitive sensor 60 in the present embodiment is equivalent to an example of the pressure-sensitive sensor in the present invention, the seal member 70 in the present embodiment is equivalent to an example of the seal member in the present invention, and the first support member 80 in the present embodiment is equivalent to an example of the support in the present invention.

Further, the first part S₁ in the present embodiment is equivalent to an example of the first part in the present invention, the second part S₂ in the present embodiment is equivalent to an example of the second part in the present invention. Furthermore, the detecting part 61 in the present embodiment is equivalent to an example of the detecting part in the present invention and the elastic member 65 in the present embodiment is equivalent to an example of the elastic member in the present invention.

### Second Embodiment

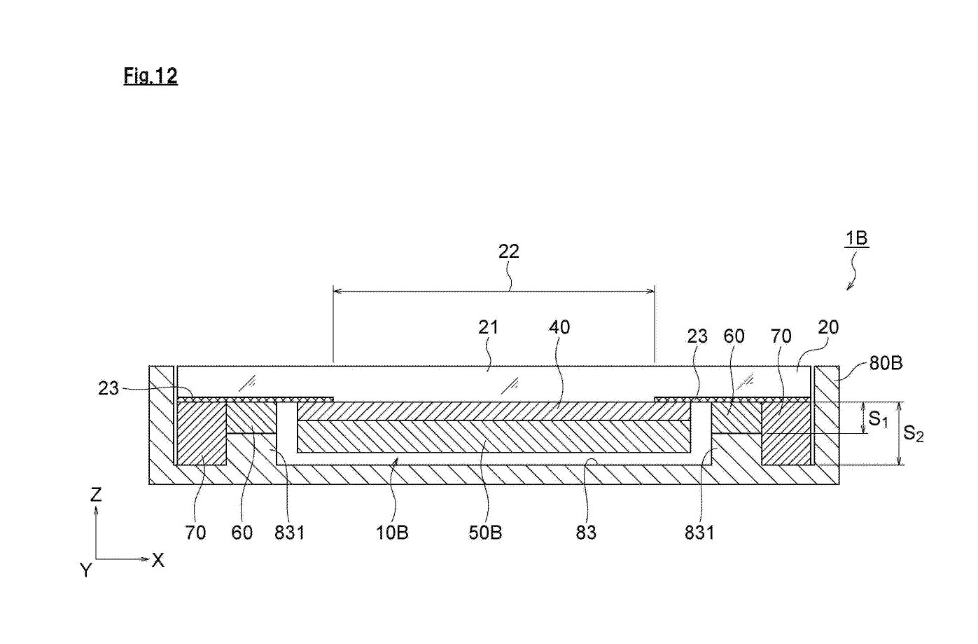

FIG. 12 is a cross-sectional view showing an input device in the second embodiment of the present invention.

An input device 1B in the second embodiment of the present invention includes, as shown in FIG. 12, a panel unit 10B, pressure-sensitive sensors 60, a seal member 70, and a support member 80B. The panel unit 10B includes a display device 50B in addition to a cover member 20 and a touch panel 40. The structures of the cover member 20, touch panel 40, pressure-sensitive sensors 60, and the seal member 70 in the present embodiment are the same as those used in the first embodiment. Accordingly, their descriptions are omitted by assigning common reference numerals.

The display device 50B in the present embodiment is similar to the one in the first embodiment in the point of including the display region 51 and the outer edge region 52, however different from the display device 50 in the first embodiment in the point that it does not include the flange 53. In the present embodiment, the display device 50B is directly attached to the lower surface of the touch panel 40 with a transparent gluing agent (a broken line part 521 in FIG. 11) applied only to the outer edge region 52. Accordingly, in the present embodiment, the display device 50B is included in the panel unit 10B and constitutes a part of the panel unit 10B and not attached to the support member 80B. With a transparent gluing agent applied to the entire top surface of the display device 50B including the display region 51, the display device 50B may be attached to the touch panel 40.

The support member 80B in the present embodiment has, as shown in FIG. 12, a box shape of a low-height with an opening at the upper part, and the panel unit 10, pressure-sensitive sensors 60, and seal member 70 are housed therein. The support member 80B supports the panel unit 10B through the pressure-sensitive sensors 60 and the seal member 70.

As in the first embodiment, the pressure-sensitive sensors 60 are arranged at the four corners of the panel unit 10B. On the other hand, the seal member 70 is arranged over the entire circumference of the panel unit 10B along the outer edge of the panel unit 10B. An annular projected part 831 that protrudes upward is formed on the bottom portion 83 of the support member 80B, and the pressure-sensitive sensors 60 are arranged on the projected part 831. The projected part 831 may be formed only at the parts of the bottom portion 83 where pressure-sensitive sensors 60 are arranged. Although the pressure-sensitive sensors 60 and the seal member 70 are arranged next to each other in the present embodiment, the pressure-sensitive sensors 60 and the seal member 70 may be arranged apart from each other.

In the present embodiment, the pressure-sensitive sensors 60 are arranged on the projected part 831 of the support member 80B. Accordingly, in the space formed between the panel unit 10B and the support member 80B, the distance of the first part S₁ where the pressure-sensitive sensors 60 are placed is relatively narrower than the distance of the second part S₂ where the seal member 70 is placed (S₁<S₂). Although not particularly illustrated in figures, as in the first embodiment, the elastic member 65 is thinner than usual, thus the total thickness of the pressure-sensitive sensor 60 is relatively thinner than the thickness of the seal member 70. Subsequently, when the panel unit 10B is pressed, the stress per unit displacement generated to the pressure-sensitive sensors 60 can be relatively larger than the stress per unit displacement generated to the seal member 70.

In the present embodiment, as in the first embodiment above, the elasticity modulus E₁ of the elastic member 65 is substantially equal to the elasticity modulus E₂ of the seal member 70 (E₁=E₂). However, the elasticity modulus is not particularly limited thereto, and the elasticity modulus E₁ of the elastic member 65 may be relatively higher than the elasticity modulus E₂ of the seal member 70 (E₁>E₂).

Although not particularly illustrated in figures, the seal member 70 may be thick and a recessed part may be formed on the bottom portion 83 of the support member 80B so as to correspond to the seal member 70, thereby the distance of the second part S₂ may be relatively wider than the distance of the first part S₁ (S₂>S₁).

Alternatively, although not particularly illustrated in figures, while the bottom portion 83 of the support member 80B may be flat (in other words, the distance of the first part S₁ and the distance of the second part S₂ may be substantially the same (S₁=S₂)), the elasticity modulus E₁ of the elastic member 65 may be relatively higher than the elasticity modulus E₂ of the seal member 70 (E₁>E₂).

As above, in the present embodiment, as in the first embodiment, the pressure-sensitive sensors 60 are relatively thinner than the seal member 70, thus the stress per unit displacement of the pressure-sensitive sensors 60 can be relatively larger than the stress per unit displacement of the seal member 70. Accordingly, the pressing force applied through the panel unit 10B can be accurately transmitted to the pressure-sensitive sensors 60, and detection accuracy of the pressure-sensitive sensors 60 improves.

The panel unit 10B in the present embodiment is equivalent to an example of the panel unit in the present invention, the pressure-sensitive sensor 60 in the present embodiment is equivalent to an example of the pressure-sensitive sensor in the present invention, the seal member 70 in the present embodiment is equivalent to an example of the seal member in the present invention, and the support member 80B in the present embodiment is equivalent to an example of the support in the present invention.

The first part S₁ in the present embodiment is equivalent to an example of the first part in the present invention, the second part S₂ in the present embodiment is equivalent to an example of the second part in the present invention. The detecting part 61 in the present embodiment is equivalent to an example of the detecting part in the present invention, and the elastic member 65 in the present embodiment is equivalent to an example of the elastic member in the present invention.

### Third Embodiment

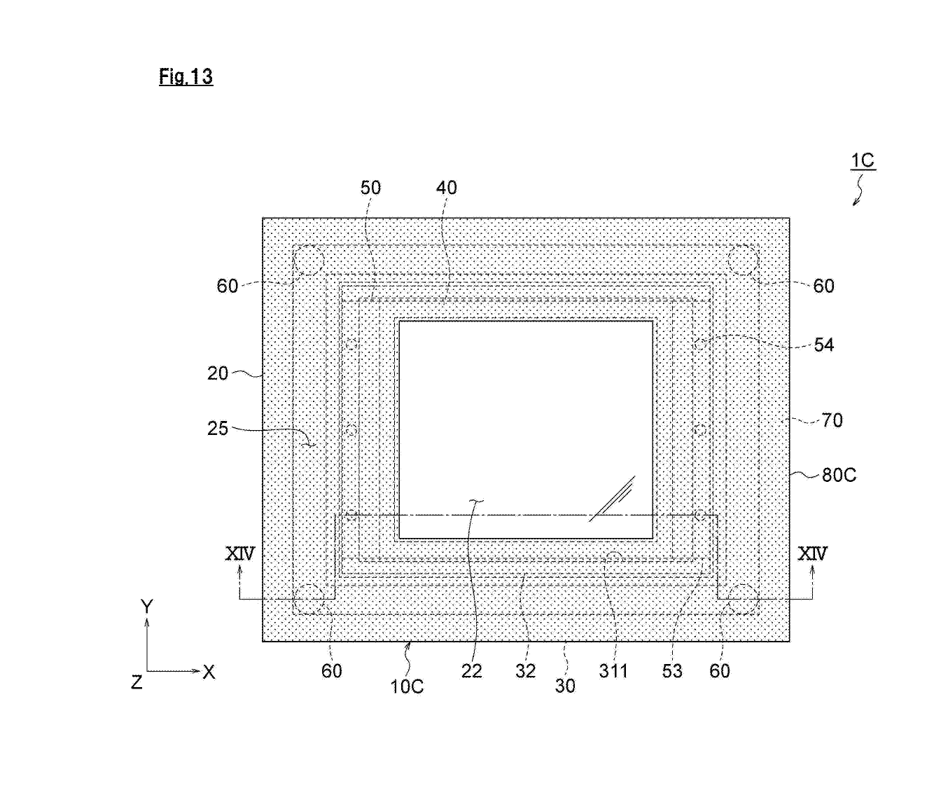

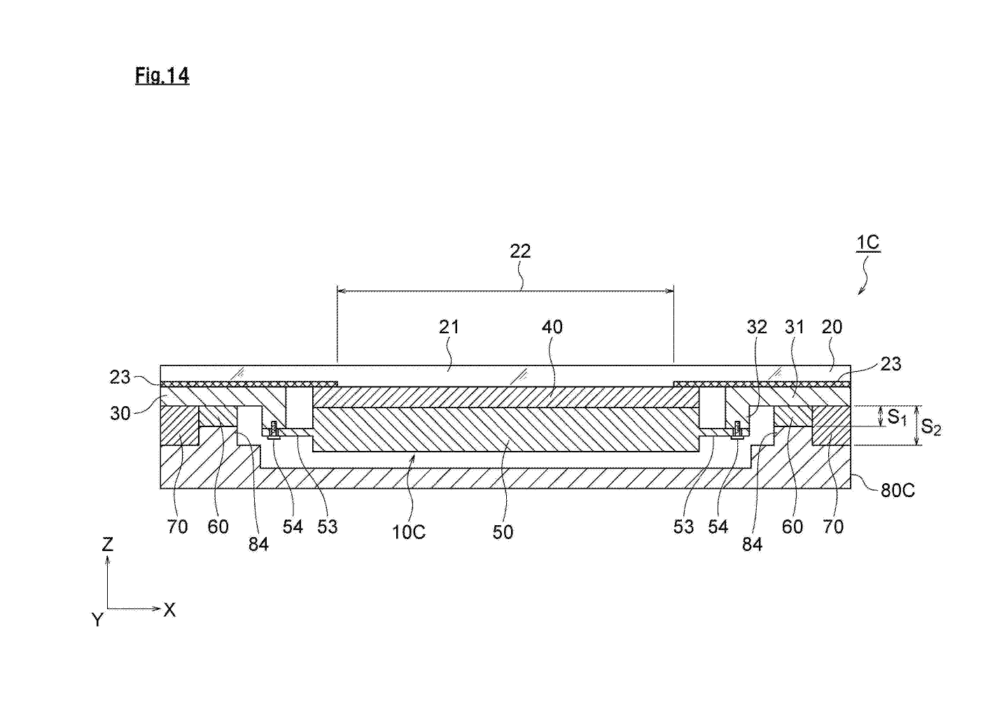

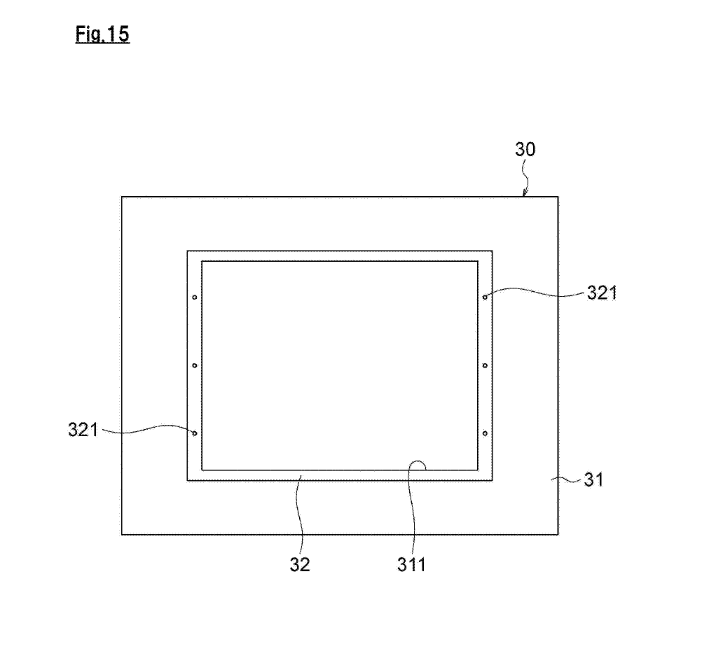

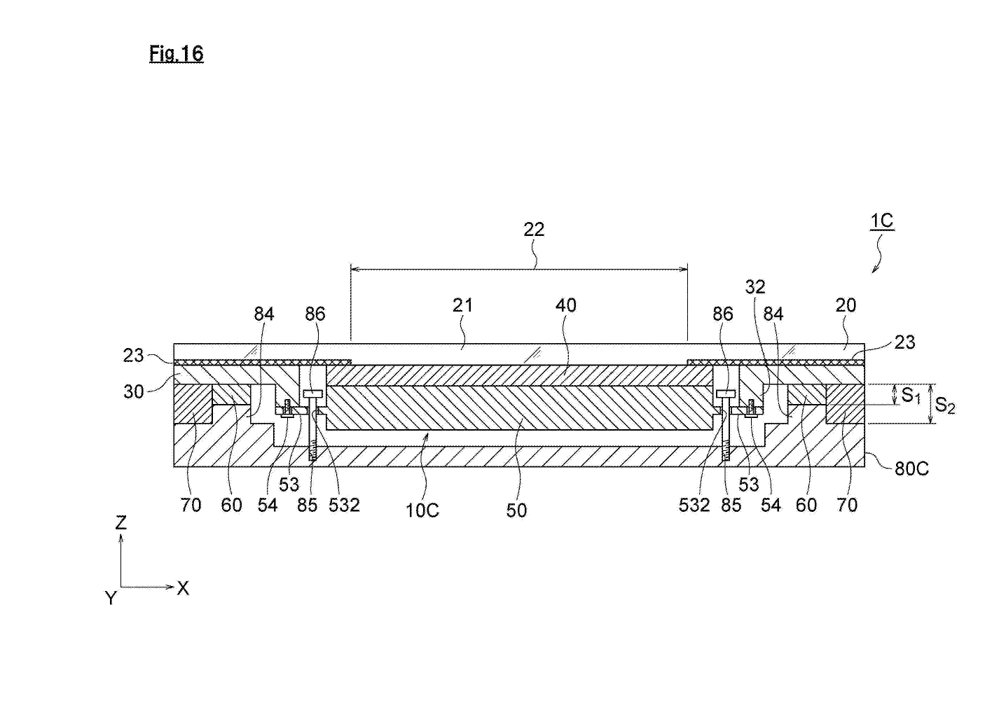

FIG. 13 is a plan view and FIG. 14 is a cross-sectional view showing an input device in the third embodiment of the present invention. FIG. 15 is a bottom view of the reinforcing member in the third embodiment of the present invention. FIG. 16 is a cross-sectional view showing a modification example of the input device in the third embodiment of the present invention.

As shown in FIG. 13 and FIG. 14, an input device 1C in the third embodiment of the present invention includes a panel unit 10C, pressure-sensitive sensors 60, a seal member 70, and a support member 80C. The panel unit 10C includes a reinforcing member 30 in addition to a cover member 20, a touch panel 40, and a display device 50. The structures of the cover member 20, the touch panel 40, the display device 50, the pressure-sensitive sensors 60, and the seal member 70 in the present embodiment are the same as those used in the first embodiment. Accordingly, their descriptions are omitted by assigning common reference numerals.

As shown in FIG. 14 and FIG. 15, the reinforcing member 30 is a frame-like shaped member fixed to the lower surface of the cover member 20 through a gluing agent. The reinforcing member 30 is attached to the shielding portion 23 of the cover member 20, and the reinforcing member 30 cannot be visually recognized by an operator.

The reinforcing member 30 includes a main body portion 31 and a protruding part 32. The main body portion 31 has a rectangular frame shape, and extends in a direction which is substantially parallel to a main surface of the cover member 20. On the other hand, the protruding part 32 has a square tubular shape which communicates with an opening 311 of the main body portion 31, and protrudes from an inner edge of the main body portion 31 toward a lower side. The reinforcing member 30 is made of a material which is hard and excellent in workability, for example, a metal material such as stainless steel (SUS), a resin material such as an ABS resin or polycarbonate (PC), or a composite material such as fiber reinforced plastic (FRP). The main body portion 31 and the protruding part 32 are integrally formed.

A screw hole 321 is formed on the tip-end surface of the protruding part 32 of the reinforcing member 30. As illustrated in FIG. 14, when a screw 54 is screwed into the screw hole 321 through the first through-hole 531 of the flange 53 (see FIG. 11), the display device 50 is fixed to the reinforcing member 30. According to this, the display region 51 faces the transparent portion 22 of the cover member 20 through the opening 311 of the reinforcing member 30.

In the present embodiment, when the screw 54 is fastened to the reinforcing member 30, the outer edge region 52 of the display device 50 is brought into close contact with a lower surface of the touch panel 40, and thus the touch panel 40 is interposed between the cover member 20 and the display device 50. According to this, a gap between the touch panel 40 and the display device 50 is not present, and thus appearance of a screen in the input device 1C is improved.

Instead of the screw 54, a gluing agent (a broken line 521 in FIG. 11) applied only to the outer edge region 52 of the display device 50 may be used to directly attach the display device 50 to the lower surface of the touch panel 40. Alternatively, the display device 50 may be attached to the touch panel 40 by a transparent gluing agent applied to the display region 51 and the outer edge region 52. In such cases, the flange 53 of the display device 50 is not required.

In the present embodiment, the display device 50 is directly fixed to the reinforcing member 30 with a screw 54. However, the fixing method of the display device 50 to the reinforcing member 30 is not particularly limited thereto. For example, although not particularly illustrated in figures, another holding plate may be placed on the rear surface side of the display device 50, the holding plate may be fixed to the reinforcing member 30 with a screw or the like, and the display device 50 may be fixed to the holding plate, thereby the display device 50 may be indirectly fixed to the reinforcing member 30 through the holding plate. In other words, as long as the display device 50 is fixed relative to the reinforcing member 30, the display device 50 may be directly fixed to the reinforcing member 30, or the display device 50 may be indirectly fixed to the reinforcing member 30.

In the present embodiment, pressure-sensitive sensors 60 and a seal member 70 are attached to the lower surface of the main body portion 31 of the reinforcing member 30 with a gluing agent. As above, in the present embodiment, the pressure-sensitive sensors 60 and the seal member 70 are arranged in the space formed below the main body portion 31 of the reinforcing member 30, thus thinning of the input device 1C can be achieved.

The pressure-sensitive sensors 60 and the seal member 70 are interposed between the panel unit 10C and the support member 80C. As in the first embodiment, the pressure-sensitive sensors 60 are arranged at the four corners of the panel unit 10C. On the other hand, the seal member 70 is arranged over the entire circumference of the panel unit 10C along the outer edge of the panel unit 10C. An annular projected part 84 that protrudes upward is formed on the support member 80C, and the pressure-sensitive sensors 60 are disposed on the projected part 84.

The projected part 84 may be formed only at the parts of the support member 80C where pressure-sensitive sensors 60 are placed. Instead of the projected part 84, or in addition to the projected part 84, a projected part may be formed on the lower surface of the main body portion 31 of the first reinforcement member 30. In the present embodiment, although the pressure-sensitive sensors 60 and the seal member 70 are arranged next to each other, the pressure-sensitive sensors 60 and the seal member 70 may be arranged apart from each other.

In the present embodiment, the pressure-sensitive sensors 60 are arranged on the projected part 84 of the support member 80C. Accordingly, in the space formed between the panel unit 10C and the support member 80C, the distance of the first part S₁ where the pressure-sensitive sensors 60 are arranged is relatively narrower than the distance of the second part S₂ where the seal member 70 is arranged (S₁<S₂). Although not particularly illustrated in figures, as in the first embodiment, the elastic member 65 is thinner than usual. As a result, the total thickness of the pressure-sensitive sensor 60 is relatively thinner than the thickness of the seal member 70. For this reason, when the panel unit 10C is pressed, the stress per unit displacement generated to the pressure-sensitive sensors 60 can be relatively larger than the stress per unit displacement generated to the seal member 70.

In the present embodiment, as in the first embodiment described above, an elasticity modulus E₁ of the elastic member 65 is substantially equal to an elasticity modulus E₂ of the seal member 70 (E₁=E₂). However, the elasticity modulus is not particularly limited thereto, and the elasticity modulus E₁ of the elastic member 65 may be relatively higher than the elasticity modulus E₂ of the seal member 70 (E₁>E₂).

Although not particularly illustrated in figures, the seal member 70 may be thick and a recessed part may be formed on the support member 80C so as to correspond to the seal member 70, thereby the distance of the second part S₂ may be relatively wider than the distance of the first part S₁ (S₂>S₁). Alternatively, the recessed part may be formed on the lower surface of the main body portion 31 of the first reinforcing member 30.

Although not particularly illustrated in figures, while the distance of the first part S₁ and the distance of the second part S₂ may be substantially the same (S₁=S₂), an elasticity modulus E₁ of the elastic member 65 may be relatively higher than an elasticity modulus E₂ of the seal member 70 (E₁>E₂).

As above, in the present embodiment, as in the first embodiment, the pressure-sensitive sensors 60 are relatively thinner than the seal member 70. Thus, the stress per unit displacement of the pressure-sensitive sensors 60 can be relatively larger than the stress per unit displacement of the seal member 70. For this reason, the pressing force applied through the panel unit 10C can be accurately transmitted to the pressure-sensitive sensors 60, and detection accuracy of the pressure-sensitive sensors 60 improves.

In the present embodiment, the cover member 20 and the display device 50 are connected through the reinforcing member 30, and the touch panel 40 is sandwiched between the cover member 20 and the display device 50, thus strength of the panel unit 10C improves.

Accordingly, the bending amount of the panel unit 10C is decreased and dispersion of the pressing force due to bending can be prevented. For this reason, even when the size of the display region of the input device 1C is expanded, the pressure-sensitive sensor 60 can accurately detect the pressure, and detection accuracy can be further improved. As the cover member 20 can be thin, thickness and weight of the input device 1C can be reduced.

The panel unit 10C in the present embodiment is equivalent to an example of the panel unit in the present invention, the pressure-sensitive sensor 60 in the present embodiment is equivalent to an example of the pressure-sensitive sensor in the present invention, the seal member 70 in the present embodiment is equivalent to an example of the seal member in the present invention, and the support member 80C in the present embodiment is equivalent to an example of the support in the present invention.

The first part S₁ in the present embodiment is equivalent to an example of the first part in the present invention, and the second part S₂ in the present embodiment is equivalent to an example of the second part in the present invention. The detecting part 61 in the present embodiment is equivalent to an example of the detecting part in the present invention, and the elastic member 65 in the present embodiment is equivalent to an example of the elastic member in the present invention.

As illustrated in FIG. 16, the second through-hole 532 in addition to the first through-hole 531 (see FIG. 11) may be formed on the flange 53 of the display device 50, a screw hole 85 be also formed on the upper surface of the support member 80C so as to face the second through-hole 532, and a bolt 86 may be fixed to the screw hole 85 through the second through-hole 532 of the display device 50.

The bolt 86 includes a head portion having an outer diameter which is greater than an inner diameter of the second through-hole 532, and a shaft portion having an outer diameter which is smaller than the inner diameter of the second through-hole 532. The bolt 86 restricts the panel unit 10C from separating from the support member 80C by a predetermined distance or more while the panel unit 10C is permitted to slightly move in a vertical direction. According to this, for example, in the case of inverting the input device 1C, the panel unit 10C is prevented from being separated from the support member 80C. The bolt 86 in the present example is equivalent to an example of the restriction device in the present invention.

### Fourth Embodiment

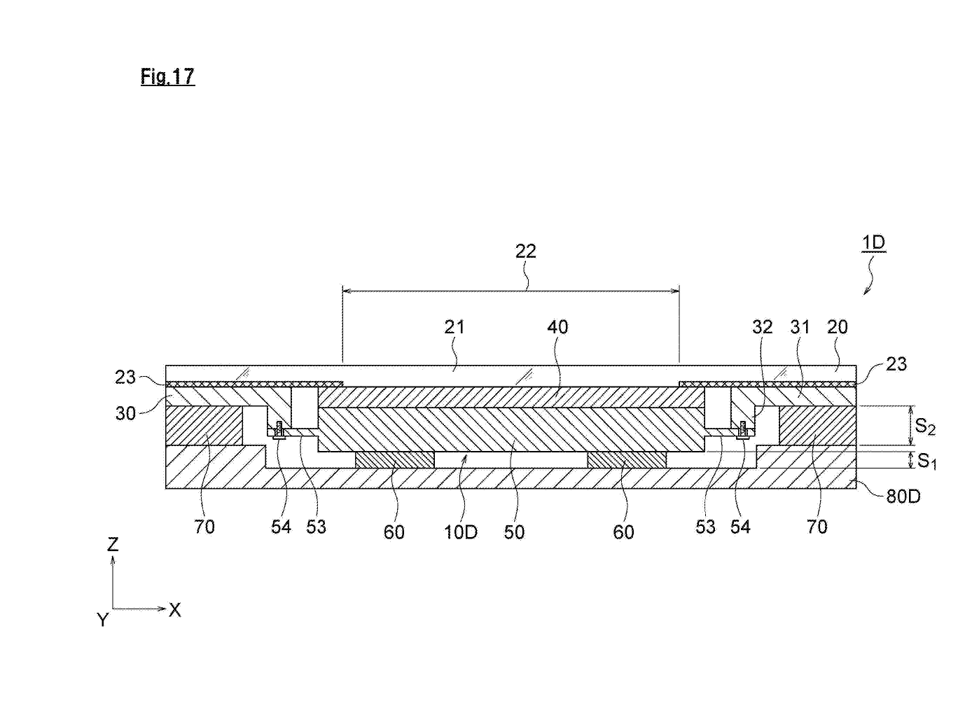

FIG. 17 is a cross-sectional view showing an input device in the fourth embodiment of the present invention.

In the present embodiment, (1) installation position of the pressure-sensitive sensors 60 and (2) structure of the support member 80D vary from those in the third embodiment. However, other structures are the same as those used in the third embodiment. In the following, the input device 1D in the fourth embodiment is described only for the point that varies from the third embodiment, and for those parts having the same structure as in the third embodiment, their descriptions are omitted by assigning common reference numerals.

In the present embodiment, as shown in FIG. 17, the pressure-sensitive sensors 60 are placed between the display device 50 and the support member 80D, thus the support member 80D does not include the projected part 84. The pressure-sensitive sensors 60 are attached to the rear surface of the display device 50 through a gluing agent and also attached to the support member 80D through the gluing agent. The panel unit 10D in FIG. 17 has a structure similar to the panel unit 10C in the third embodiment described above, and includes a cover member 20, a reinforcing member 30, a touch panel 40, and a display device 50.

In the present embodiment, the first space S₁ between the display device 50 and the support member 80D is relatively narrower than the second space S₂ between the reinforcing member 30 and the support member 80D (S₁<S₂). Although not particularly illustrated in figures, as in the first embodiment, the elastic member 65 is thinner than usual. Thus, the total thickness of the pressure-sensitive sensor 60 is relatively thinner than the thickness of the seal member 70. Accordingly, when the panel unit 10D is pressed, the stress per unit displacement generated to the pressure-sensitive sensors 60 can be relatively larger than the stress per unit displacement generated to the seal member 70.

In the present embodiment, as in the first embodiment described above, an elasticity modulus E₁ of the elastic member 65 is substantially equal to an elasticity modulus E₂ of the seal member 70 (E₁=E₂). However, the elasticity modulus is not particularly limited thereto, and the elasticity modulus E₁ of the elastic member 65 may be relatively higher than the elasticity modulus E₂ of the seal member 70 (E₁>E₂).

Although not particularly shown in figures, the seal member 70 may be thick and the distance of the second part S₂ may be relatively made wider than the distance of the first part S₁ (S₂>S₁).

Alternatively, although not particularly illustrated in figures, while the distance of the first part S₁ and the distance of the second part S₂ may be substantially the same (S₁=S₂), the elasticity modulus E₁ of the elastic member 65 may be relatively higher than the elasticity modulus E₂ of the seal member 70 (E₁>E₂).

As above, in the present embodiment, as in the first embodiment, the pressure-sensitive sensors 60 are relatively thinner than the seal member 70. Thus, the stress per unit displacement of the pressure-sensitive sensors 60 can be made relatively larger than the stress per unit displacement of the seal member 70. Accordingly, the pressing force applied through the panel unit 10D can be accurately transmitted to the pressure-sensitive sensors 60 and detection accuracy of the pressure-sensitive sensors improves.

In the present embodiment, as in the third embodiment, the cover member 20 and the display device 50 are connected through a reinforcing member 30. Also, the touch panel 40 is sandwiched between the cover member 20 and the display device 50, thus strength of the panel unit 10D improves.

Accordingly, the bending amount of the panel unit 10D is decreased and the pressure can be accurately detected by the pressure-sensitive sensors 60 even when the size of the display region of the input device 1D is expanded and detection accuracy can be further improved. As the cover member 20 can be made thin, thickness and weight of the input device 1D can be reduced.

Further, in the present embodiment, the pressure-sensitive sensors 60 are placed on the rear surface of the display device 50. Thus, bending of the panel unit 10D due to pressing can be reduced and sensitivity of the pressure-sensitive sensors 60 can be improved and a dynamic range of the pressure-sensitive sensors 60 can be widened.

The panel unit 10D in the present embodiment is equivalent to an example of the panel unit in the present invention, the pressure-sensitive sensor 60 in the present embodiment is equivalent to an example of the pressure-sensitive sensor in the present invention, the seal member 70 in the present embodiment is equivalent to an example of the seal member in the present invention, and the support member 80D in the present embodiment is equivalent to an example of the support in the present invention.

The first part S₁ in the present embodiment is equivalent to an example of the first part in the present invention and the second part S₂ in the present embodiment is equivalent to an example of the second part in the present invention. The detecting part 61 in the present embodiment is equivalent to an example of the detecting part in the present invention, and the elastic member 65 in the present embodiment is equivalent to an example of the elastic member of the present invention.

### Fifth Embodiment

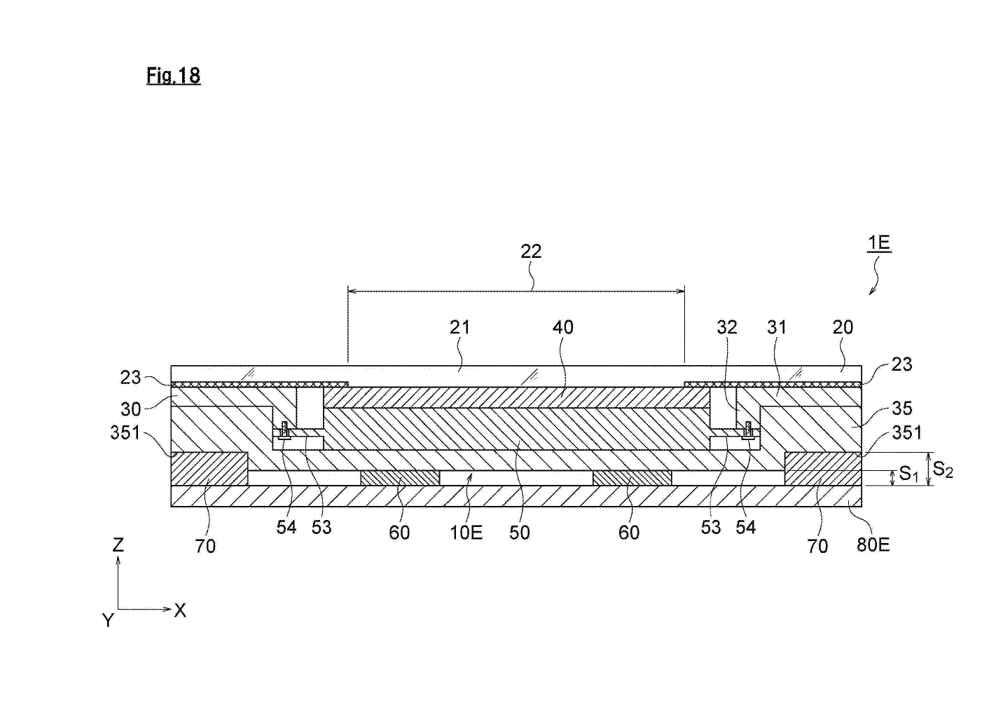

FIG. 18 is a cross-sectional view showing an input device in the fifth embodiment of the present invention.

In the present embodiment, (1) structure of a panel unit 10E, (2) installation positions of pressure-sensitive sensors 60 and a seal member 70, and (3) structure of a support member 80E vary from the third embodiment. However, other structures are the same as those in the third embodiment. In the following, the structure of the input device 1E in the fifth embodiment is described only for the point that varies from the third embodiment, and for those parts having the same structure as in the third embodiment, their descriptions are omitted by assigning common reference numerals.

In the present embodiment, as shown in FIG. 18, a panel unit 10E includes a second reinforcing member 35 in addition to a cover member 20, a first reinforcing member 30, a touch panel 40, and a display device 50.

The second reinforcing member 35 is fixed to the lower surface of the main body portion 31 of the first reinforcing member 30 through a gluing agent, and covers the rear surface of the display device 50. The second reinforcing member 35 is made of the same material that constitutes the first reinforcing member 30 described above. Instead of the gluing agent, the first reinforcing member 30 and the second reinforcing member 35 may be fastened with a screw.

In the present embodiment, the pressure-sensitive sensors 60 are placed between the second reinforcing member 35 and the support member 80E. The pressure-sensitive sensors 60 are attached to the lower surface of the second reinforcing member 35 through a gluing agent and also attached to the support member 80E through the gluing agent.

Similarly, a seal member 70 is also placed between the second reinforcing member 35 and the support member 80E. The seal member 70 is attached to the lower surface of the second reinforcing member 35 through a gluing agent, and also attached to the support member 80E through the gluing agent.

In the present embodiment, a recessed part 351 is formed on the lower surface of the second reinforcing member 35 along the outer edge of the second reinforcing member 35, and the support member 80E is constituted by a flat member. Thus, between the second reinforcing member 35 and the support member 80E, the first space S₁ where the pressure-sensitive sensors 60 are arranged is relatively narrower than the second space S₂ where the seal member 70 is arranged (S₁<S₂). Although not particularly shown in figures, as in the first embodiment, the elastic member 65 is thinner than usual. Thus, the total thickness of the pressure-sensitive sensor 60 is relatively thinner than the thickness of the seal member 70. Accordingly, when the panel unit 10E is pressed, the stress per unit displacement generated to the pressure-sensitive sensors 60 can be relatively larger than the stress per unit displacement generated to the seal member 70.

In the present embodiment, as in the first embodiment, an elasticity modulus E₁ of the elastic member 65 is substantially equal to an elasticity modulus E₂ of the seal member 70 (E₁=E₂). However, the elasticity modulus is not particularly limited thereto and the elasticity modulus E₁ of the elastic member 65 may be relatively higher than the elasticity modulus E₂ of the seal member 70 (E₁>E₂).

Although not particularly shown in figures, a recessed part may be formed on the support member 80E, thereby the first space S₁ may be relatively narrower than the second space S₂ (S₁<S₂). Alternatively, although not particularly shown in figures, a projected part may be formed on at least one of the second reinforcing member 35 and the support member 80E so as to correspond to the pressure-sensitive sensors 60, thereby the first space S₁ may be relatively narrower than the second space S₂ (S₁<S₂).

Although not particularly shown in figures, the seal member 70 may be thick and also the distance of the second part S₂ may be relatively wider than the distance of the first part S₁ (S₂>S₁).

Although not particularly shown in figures, while the distance of the first part S₁ and the distance of the second part S₂ may be substantially the same (S₁=S₂), the elasticity modulus E₁ of the elastic member 65 may be relatively higher than the elasticity modulus E₂ of the seal member 70 (E₁>E₂).

As above, in the present embodiment, as in the first embodiment, the pressure-sensitive sensors 60 are relatively thinner than the seal member 70. Thus, the stress per unit displacement of the pressure-sensitive sensors 60 can be relatively larger than the stress per unit displacement of the seal member 70. Accordingly, the pressing force applied through the panel unit 10E can be accurately transmitted to the pressure-sensitive sensors 60 and detection accuracy of the pressure-sensitive sensors 60 improves.

In the present embodiment, as in the third embodiment, a cover member 20 and a display device 50 are connected through a reinforcing member 30, and a touch panel 40 is sandwiched between the cover member 20 and the display device 50, thus the strength of the panel unit 10E improves.

For these reasons, the bending amount of the panel unit 10E is decreased and even when the size of the display region of the input device 1E is expanded, the pressure can be accurately detected by the pressure-sensitive sensors 60, thus detection accuracy can be further improved. As the cover member 20 can be thin, thickness and weight of the input device 1E can be reduced.

Further, in the present embodiment, the pressure-sensitive sensors 60 are placed on the rear side of the second reinforcing member 35. Accordingly, bending of the panel unit 10E due to pressing can be reduced and sensitivity of the pressure-sensitive sensors 60 can be improved and also a dynamic range of the pressure-sensitive sensors 60 can be widened.

The panel unit 10E in the present embodiment is equivalent to an example of the panel unit in the present invention, the pressure-sensitive sensor 60 in the present embodiment is equivalent to an example of the pressure-sensitive sensor in the present invention, the seal member 70 in the present embodiment is equivalent to an example of the seal member in the present invention, and the support member 80E in the present embodiment is equivalent to an example of the support in the present invention.

The first part S₁ in the present embodiment is equivalent to an example of the first part in the present invention, and the second part S₂ in the present embodiment is equivalent to an example of the second part in the present invention. The detecting part 61 in the present embodiment is equivalent to an example of the detecting part in the present invention, and the elastic member 65 in the present embodiment is equivalent to an example of the elastic member in the present invention.

The embodiments described above are for easy understanding of the present invention, and is not intended to limit the invention. Accordingly, respective elements disclosed in the above embodiments are intended to include all design modifications or equivalents thereof which pertain to the technical scope of the invention.

For example, the restriction device (see FIG. 16) of the panel unit described in the modification example of the third embodiment may be added to the input device 1D in the fourth embodiment or the input device 1E in the fifth embodiment.

The panel unit preferably includes at least a position input function (touch panel), however, there is no particular limitation thereto. The panel unit may not include the touch panel and, for example, constituted only by a cover member.

### DESCRIPTION OF REFERENCE NUMERALS

1, 1B to 1E . . . input device
10, 10B to 10E . . . panel unit
20 . . . cover member
30 . . . reinforcing member
35 . . . second reinforcing member
40 . . . touch panel
50, 50B . . . display device
60, 60B . . . pressure-sensitive sensor
61 . . . detecting part
65 . . . elastic member
70 . . . seal member
80, 80B to 80E . . . support member
81 . . . frame part
82 . . . holder
821 . . . first region
822 . . . second region
823 . . . center opening
S1 . . . first part
S2 . . . second part
83 . . . bottom part
831 . . . projected part
84 . . . projected part

1. An input device comprising:
a panel unit;
a pressure-sensitive sensor which detects a pressing force applied through the panel unit;
a seal member which is disposed outside the pressure-sensitive sensor; and
a support which supports the panel unit through the pressure-sensitive sensor and the seal member, wherein
a thickness of the pressure-sensitive sensor is relatively thinner than a thickness of the seal member,
a space which is formed between the panel unit and the support includes:
a first part where the pressure-sensitive sensor is arranged; and
a second part where the seal member is arranged, and
a distance of the first part is relatively narrower than a distance of the second part.

2. The input device according to claim 1, wherein
the pressure-sensitive sensor includes:
a detecting part which detects the pressing force; and
an elastic member which is disposed on at least one of an upper side and a lower side of the detecting part.

3. The input device according to claim 2, wherein
an elasticity modulus of the elastic member is relatively higher than an elasticity modulus of the seal member.

4. The input device according to claim 1, wherein
the input device further comprising a restriction device which restricts the panel unit from separating from the support by a predetermined distance or more.

5. An input device comprising:
a panel unit;
a pressure-sensitive sensor which detects a pressing force applied through the panel unit;
a seal member which is disposed outside the pressure-sensitive sensor; and
a support which supports the panel unit through the pressure-sensitive sensor and the seal member, wherein
the pressure-sensitive sensor includes:
a detecting part which detects the pressing force; and
an elastic member which is disposed on at least one of an upper side and a lower side of the detecting part, and
an elasticity modulus of the elastic member is relatively higher than an elasticity modulus of the seal member.
